(19) United States
(12) Patent Application Publication
(10) Pub. No.: US 2008/0181648 A1
(43) Pub. Date: Jul. 31, 2008

(54) IMAGE FORMING APPARATUS AND IMAGE FORMING PROCESS CONTROLLING METHOD

(75) Inventors: Shinji Makishima, Tokyo (JP); Kazuhiro Ogura, Kanagawa-ken (JP); Akihiro Mizutani, Tokyo (JP); Toshihiro Ida, Tokyo (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/668,158

(22) Filed: Jan. 29, 2007

(51) Int. Cl. G03G 15/00; G03G 21/00

(52) U.S. Cl. 399/75

(57) ABSTRACT

A technique that can realize efficiency of control of an image forming process corresponding to a motion state of a user is provided.

An image forming apparatus that performs a predetermined process according to a motion state of a user includes a schedule-information acquiring unit 101 that acquires information on a schedule of the user, a user estimating unit 102 that estimates, on the basis of the information acquired by the schedule-information acquiring unit, a user who is highly likely to use the image forming apparatus, a state-information acquiring unit 103 that acquires state information concerning a motion state of the user estimated by the user estimating unit 102, and a process executing unit 104 that causes, on the basis of the state information acquired by the state-information acquiring unit, the image forming apparatus to execute the predetermined process for the user, the state information of whom is acquired.

### NOTICE OF COPYRIGHT AND TRADE DRESS

A portion of the disclosure of this patent document contains material which is subject to copyright protection. This patent document may show and/or describe matter which is or may become trade dress of the owner. The copyright and trade dress owner has not objection to the facsimile reproduction by any one of the patent disclosure as it appears in the Patent and Trademark Office patent files or records, but otherwise reserves all copyright and trade dress rights whatsoever.

### BACKGROUND OF THE INVENTION

1. Field of the Invention

The present invention relates to control of an image forming process, and, more particularly to efficiency of control of an image forming process corresponding to a motion state of a user.

2. Description of the Related Art

Conventionally, as a technique for efficiently distributing materials used in meetings and the like, there is known a technique for transmitting a notice of meeting to participants in the meeting and accumulating participation information to instruct printing of a necessary number of materials (JP-A-2000-137653). In the conventional technique, it is possible to store and manage materials in a server and execute a printing process according to operation from a copying machine.

There is also known a technique for, taking security into account, providing an individual authenticating function in an image forming apparatus and authenticating participants in a meeting, who make reservations in a scheduler or the like, to make it possible to print materials registered in advance. However, since a user needs to wait for printing in front of the image forming apparatus, this technique is not preferable in terms of efficiency of work.

The invention has been devised to solve the problems and it is an object of the invention to provide a technique that can realize efficiency of control of an image forming process corresponding to a motion state of a user.

### DESCRIPTION OF THE DRAWINGS

FIG. 1 is an overall diagram of a network including an image forming apparatus according to a first embodiment of the invention;

FIG. 2 is a diagram showing an example of information managed by a scheduler 2;

FIG. 3 is an example of a data table showing a correspondence relation between meeting IDs and IDs of participants in the meeting;

FIG. 4 is a table showing an example of information managed in a state managing system 3;

FIG. 5 is a functional block diagram for explaining the image forming apparatus according to the embodiment;

FIG. 6 is a flowchart showing details of a process in an image forming apparatus according to the embodiment;

FIG. 7 is a flowchart showing details of a process in the image forming apparatus according to the embodiment;

FIG. 8 is a flowchart showing details of a process in the image forming apparatus according to the embodiment;

FIG. 9 is a diagram showing an example of screen display of a control panel in an image forming apparatus according to a second embodiment of the invention;

FIG. 10 is a diagram for explaining details of a process in the image forming apparatus according to the embodiment; and

FIG. 11 is a flowchart for explaining a rough flow of a process (an image forming process controlling method) in the image forming apparatus according to the embodiment of the invention.

### DETAILED DESCRIPTION OF THE INVENTION

Embodiments of the invention will be hereinafter explained with reference to the drawings.

Through this description, the embodiments and examples shown should be considered as exemplars, rather than limitations on the apparatus, methods, and programs of the present invention.

### First Embodiment

First, an image forming apparatus according to a first embodiment of the invention will be explained.

For convenience of explanation, an example in which control for a predetermined process in the image forming apparatus is performed using a “schedule related to a meeting” of a user is described below. However, the control does not always have to be based on the schedule related to a meeting. The control only has to be based on information indicating that the user would use a certain image forming apparatus.

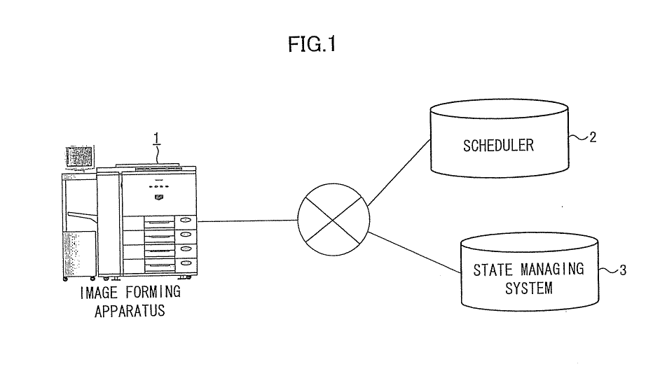

FIG. 1 is an overall diagram of a network including the image forming apparatus according to this embodiment. The network shown in FIG. 1 includes an image forming apparatus 1 according to this embodiment, a scheduler 2, and a state managing system 3. The image forming apparatus 1, the scheduler 2, and the employee-state managing system 3 are communicatably connected to one another via a network line such as a LAN or the Internet. It is assumed that the image forming apparatus 1 in this context is installed in, for example, a meeting room in which a meeting by users is held.

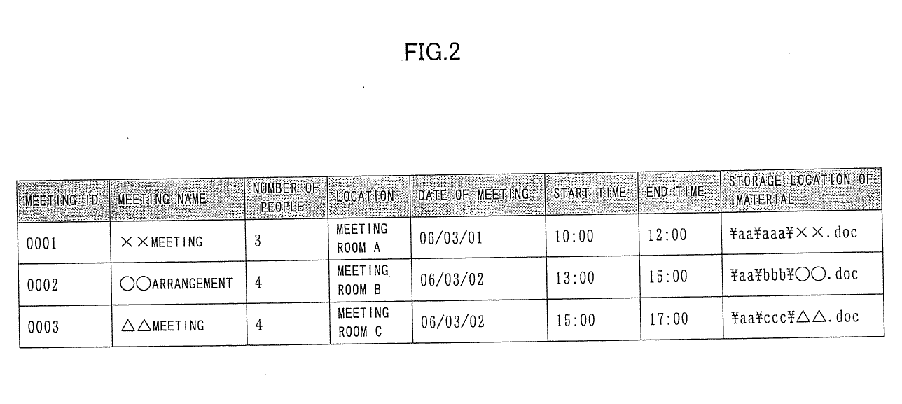

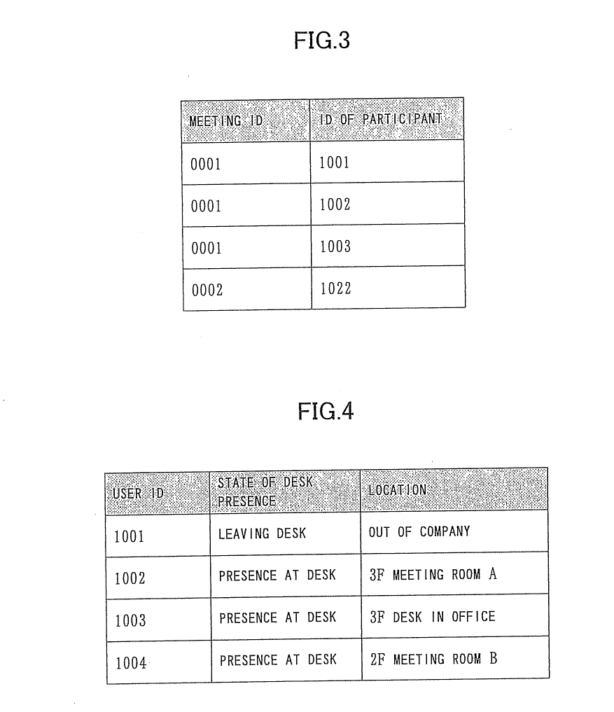

The scheduler 2 accepts a reservation for a meeting from the user and manages schedule information (an action schedule and a work schedule) of participants in the meeting, electronic files of meeting materials, and the like. It is assumed that, for example, as shown in FIG. 2, the scheduler 2 manages meeting IDs, meeting names, the numbers of participants in meetings, locations of meetings, dates of meetings, start times of meetings, end times of meetings, storage locations of meeting materials, and IDs of participants in meetings. The scheduler 2 has a function of providing these pieces of information as objects of management to the outside via the network. FIG. 3 is an example of a data table showing a correspondence relation between meeting IDs and IDs of participants in meetings.

The state managing system 3 has a role of managing information on a real-time motion state of the user (desk presence information, position information, and the like of the user). The image forming apparatus 1 is capable of using the information managed by the state managing system 3 by accessing this state managing system 3 through the network.

The state managing system 3 in this context corresponds to a so-called presence service. The state managing system 3 manages information on a real-time motion state of the user such as desk presence information and position information of the user and notifies an event of a state change to the outside by acquiring information of a GPS, an RFID, an entrance and exit IC card, ON and OFF of a power supply of a personal computer, and the like via the network.

FIG. 4 is a table showing an example of the information managed by the state managing system 3. The state managing system 3 manages information such as IDs of users (employees), desk presence states such as “present at the desk” and “leaving the desk”, and locations of users and has a function of notifying an event of a desk presence state to the outside.

Subsequently, a structure of the image forming apparatus 1 is explained in detail.

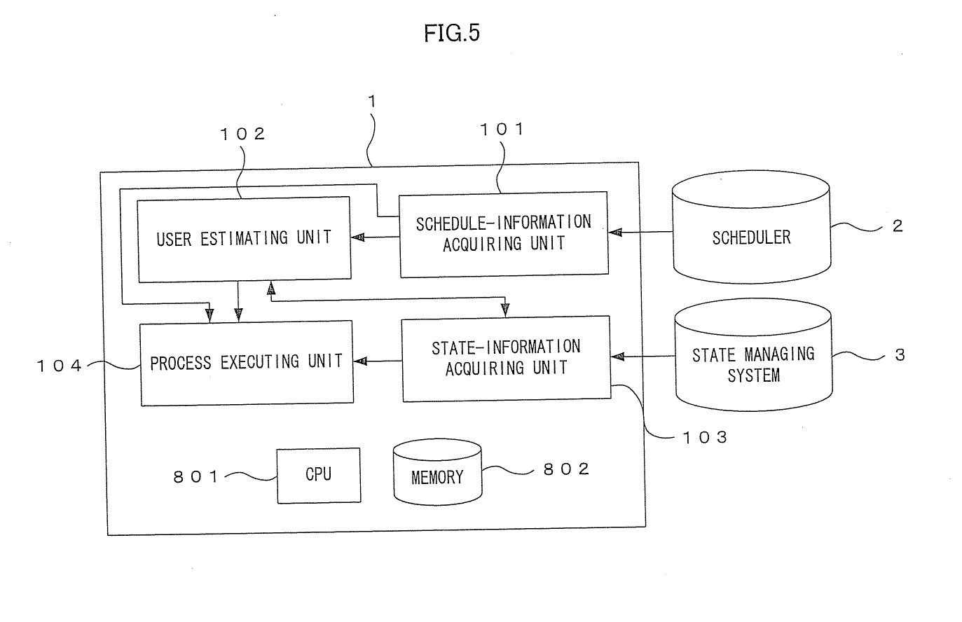

FIG. 5 is a functional block diagram for explaining the image forming apparatus according to this embodiment. The image forming apparatus according to this embodiment has a function of performing a predetermined process in response to a motion state of the user. The image forming apparatus includes a schedule-information acquiring unit 101, a user estimating unit 102, a state-information acquiring unit 103, a process executing unit 104, a CPU 801, and a MEMORY 802.

The schedule-information acquiring unit 101 acquires information on a schedule of the user (e.g., schedule information defining an action schedule of the user) from the scheduler 2.

The user estimating unit 102 estimates, on the basis of the schedule information acquired by the schedule-information acquiring unit 101, that, for example, a user moving to an installation location of the image forming apparatus 1 is highly likely to use the image forming apparatus 1.

The “installation location” in this context means a location where a meeting is held. The “user moving to the installation location” means a user planning to participate in the meeting to be held in the installation location. It goes without saying that the estimation of a user who uses the image forming apparatus does not have to be performed on the basis of only a schedule. It is also possible to perform the estimation on the basis of a schedule, a present location of the user, and the like.

An image forming apparatus arranged in a room in which a certain meeting is held may automatically estimate a participant in the meeting as a user who is highly likely to use the image forming apparatus considering that the image forming apparatus is highly likely to be used by a user participating in the meeting.

The state-information acquiring unit 103 acquires state information concerning a motion state of the user (a desk presence state and the like of the user) estimated by the user estimating unit 102 from the state managing system 3.

The process executing unit 104 causes, on the basis of the state information acquired by the state-information acquiring unit 103, the image forming apparatus 1 to execute a predetermined process for the user, the state information of whom is acquired.

Specifically, the process executing unit 104 causes, on the basis of the state information acquired by the state-information acquiring unit 103, the image forming apparatus 1 to execute an image forming process for a print that should be distributed to the user, the state information of whom is acquired, and causes, on the basis of the state information acquired by the state-information acquiring unit, the image forming apparatus 1 to perform a warming-up process for the image forming apparatus 1. Besides, the process executing unit 104 can automatically acquire and print data of a FAX or the like transmitted to the user, the state information of whom is acquired (i.e., the user who is highly likely to use the image forming apparatus 1). Consequently, the user can efficiently receive the FAX transmitted to the user while moving around a company.

It is possible to easily determine the print, which should be distributed to the user, on the basis of, for example, the information on materials associated with meeting IDs as in the data table shown in FIG. 2 and the association of meeting IDs and IDs of participating users shown in FIG. 3.

The process executing unit 104 causes, on the basis of the state information acquired by the state-information acquiring unit 103, the image forming apparatus 1 to execute a predetermined process for the user, the state information of whom is acquired, when the user leaves a desk of the user at time near time a predetermined time earlier than time when the user should arrive at the installation location (the meeting room). The “predetermined time” is time required by the user, the state information of whom is acquired, to move from the desk of the user to the installation location. Since some users always arrive at the meeting room five minutes before the start of a meeting, it is likely that the “predetermined time” fluctuates for each user. Thus, the “predetermined time” may be estimated by determining history information concerning desk leaving timing or the like of the user with respect to meeting start times in the past from the information of the state-information managing system 3 and the scheduler 2.

The CPU 801 has a role of performing various processes in the image forming apparatus 1. The CPU 801 also has a role of realizing various functions by executing programs stored in the MEMORY 802. The MEMORY 802 includes, for example, a ROM and a RAM and has a role of storing various kinds of information and programs used in the image forming apparatus.

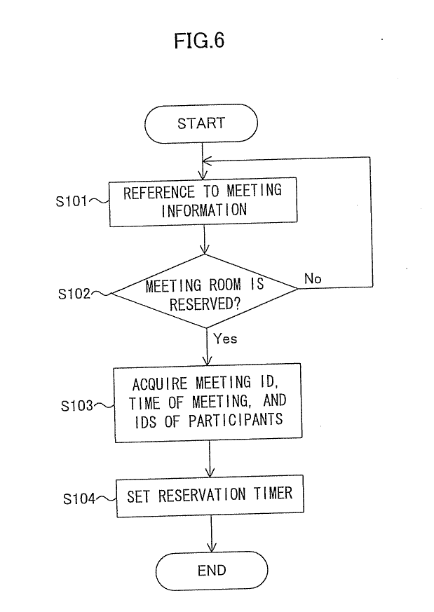

Subsequently, details of processes in the image forming apparatus according to this embodiment are explained. FIGS. 6, 7, and 8 are flowcharts showing details of the processes in the image forming apparatus according to this embodiment.

The schedule-information acquiring unit 101 periodically accesses the scheduler 2 and inquires the scheduler 2 whether a reservation for a meeting to be held in the meeting room, in which the image forming apparatus 1 is installed, is made with reference to a meeting information table (S101).

The schedule-information acquiring unit 101 determines whether there is a meeting for which the meeting room is reserved (S102). When there is no meeting for which the meeting room is reserved (S102, No), the schedule-information acquiring unit 101 returns to S101.

On the other hand, when there is a meeting for which the meeting room is reserved (S102, Yes), the schedule-information acquiring unit 101 inquires the scheduler 2 about an ID and time of the meeting for which the meeting room is reserved and acquires the ID and the time of the meeting (S103).

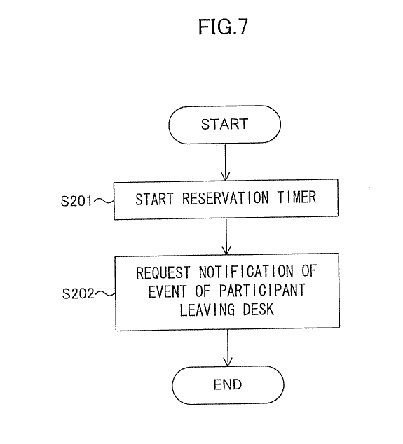

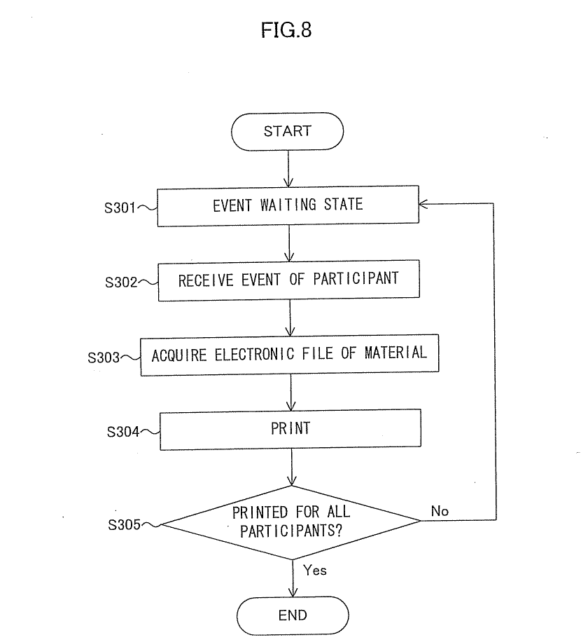

Subsequently, the schedule-information acquiring unit 101 sets a timer for advancing a process in FIG. 7 described later to time near the time of the meeting for which the meeting room is reserved (S104). The meeting ID and IDs of participants are held in the MEMORY 802.

When the time of the meeting approaches, the timer set in S104 starts (S201).

The state-information acquiring unit 103 accesses the state managing system 3 and requests a notice of an event of desk presence states of people planning to participate in the meeting on the basis of IDs of people planning to participate in the meeting (S202).

Subsequently, in a state of waiting for an event from the state managing system (S301), when an event indicating that a user planning to participate in the meeting comes into a state of leaving a desk is received from the state managing system 3 (S302), the process executing unit 104 accesses the scheduler 2, acquires an electronic file of a meeting material on the basis of the meeting ID (S303), and perform printing (S304).

The process executing unit 104 checks, on the basis of the information on the participants in the meeting (see FIG. 3), whether printing of the material for all the people planning to participate in the meeting has been completed (S305). When the printing is not completed (S305, No), the process executing unit 104 returns to S301. When the printing is completed (S305, Yes), the process executing unit 104 finishes the event waiting process.

In the embodiment described above, the process executing unit 104 receives the events of the desk presence and desk leaving states of the user planning to participate in the meeting from the state managing system 3. However, the invention is not limited to this. The process executing unit 104 may start printing by receiving an event of entrance of a participant into a meeting from the state managing system 3. In this case, the process executing unit 104 starts printing when the process executing unit 104 receives, from the state managing system 3, an event indicating that a location of the user is changed to the designated meeting room.

According to such a constitution, in a state in which the image forming apparatus installed in the meeting room or the like is connected to the network, the user reserves the meeting room for a meeting designating, in a scheduler, participants, a date and time, a location, and an electronic file used as a material. Then, when a user planning to participate in the meeting leaves a desk of the user at time near time of the meeting, it is possible to automatically print the material.

### Second Embodiment

A second embodiment of the invention will be explained.

This embodiment is a modification of the first embodiment described above. This embodiment and the first embodiment are the same in basic structures thereof. However, processes performed on the basis of state information acquired from the state managing system 3 are different.

In the image forming apparatus according to this embodiment, the state-information acquiring unit 103 acquires state information concerning a motion state of a user from the state managing system 3 and the schedule-information acquiring unit 101 acquires information (an address, a name, an ID, etc.) specifying a location where a meeting or the like is held from, for example, the scheduler 2. Thereafter, the image forming apparatus specifies, with the process executing unit 104, the number of users present in the location, where the meeting or the like is held, on the basis of the state information acquired by the state information acquiring unit 103 and sets the number in the number of prints to perform an image forming process for a predetermined meeting material and the like. The process executing unit 104 acquires a material and the like as objects of the image forming process from, for example, the scheduler 2.

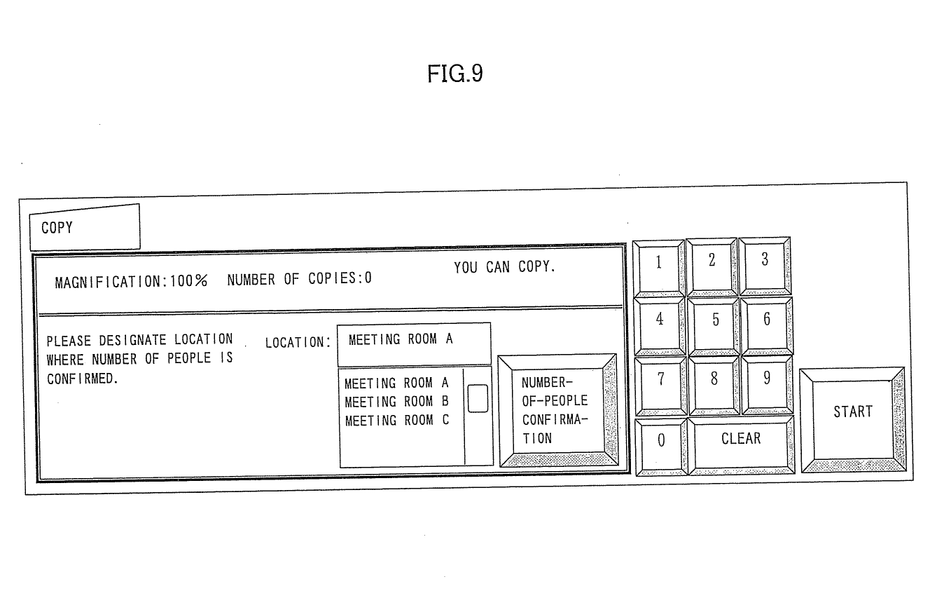

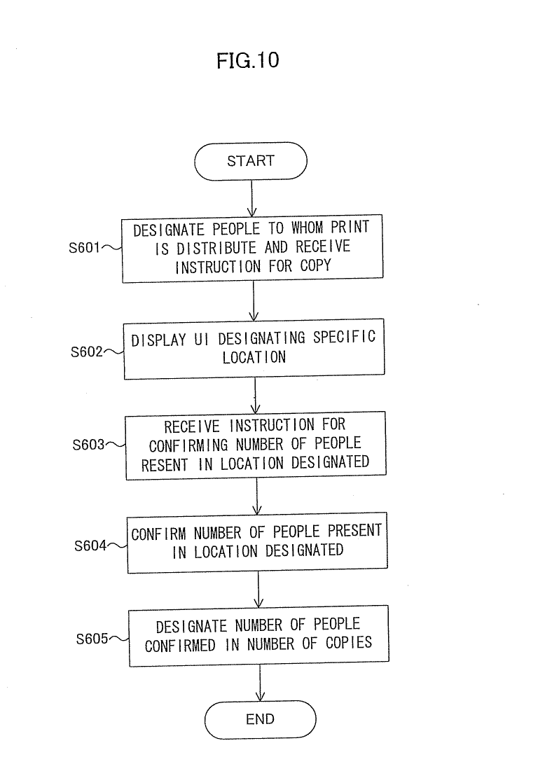

FIG. 9 is a diagram showing an example of screen display of a control panel in the image forming apparatus according to this embodiment. FIG. 10 is a diagram for explaining details of processes in the image forming apparatus according to this embodiment.

The example of the display of the control panel shown in FIG. 9 is a screen displayed after a number-of-copies designation button is depressed by the user in S601. The user designates a specific location on the screen. On the display screen shown in FIG. 9, the user can designate an object location (a meeting room name, etc.) in a list box or the like (S601 and S602).

A “number-of-people confirmation” button shown in FIG. 9 is a button for requesting confirmation of the number of users present in the location designated. In S602, the screen in FIG. 9 is displayed on an operation panel.

When the user designates a location on the screen in FIG. 9 and depresses the number-of-people confirmation button, the image forming apparatus is instructed to confirm the number of people (S603).

The state-information acquiring unit 103 accesses the data managed by the state managing system 3 (see FIG. 4) and acquires IDs of the users present in the location designated in S603 (S604).

The process executing unit 104 sets the number of users confirmed in S604 (the number of people determined as being present in the designated location on the basis of the information from the state managing system) in the number of copies of the operation panel and executes an image forming process (S605).

In this way, according to this embodiment, it is possible to provide the image forming apparatus that performs a predetermined process according to a motion state of a user, the image forming apparatus including the schedule-information acquiring unit that acquires information on a location of a meeting, the state-information acquiring unit that acquires, on the basis of the information acquired by the schedule-information acquiring unit, information on the number of users present in the location of the meeting, and the process executing unit that causes, on the basis of the information on the number of users acquired by the state-information acquiring unit, the image forming apparatus to execute an image forming process for a predetermined material, in the number of copies of which the number of people is set. The predetermined material in this context is, for example, a material planned to be used in the meeting.

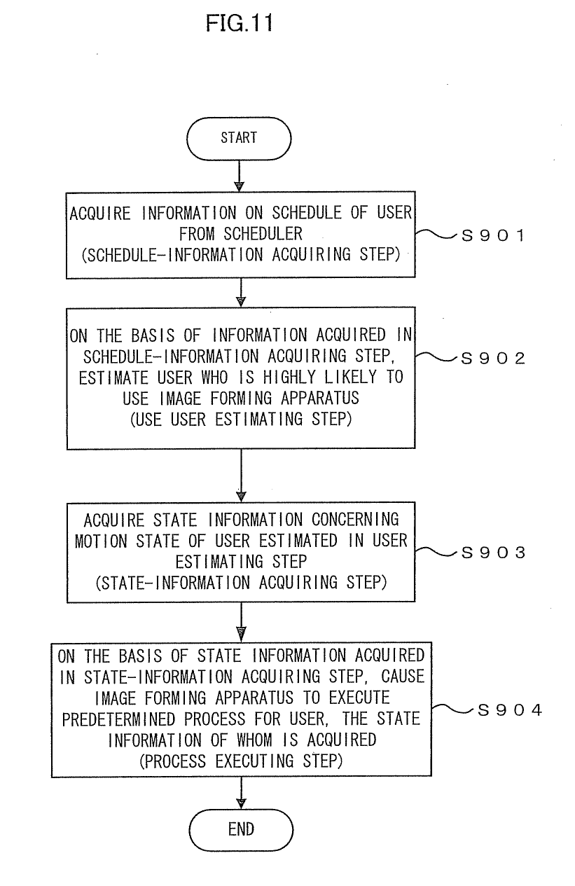

FIG. 11 is a flowchart for explaining a rough flow of a process (an image forming process controlling method) in the image forming apparatus according to the embodiment of the invention.

The schedule-information acquiring unit 101 acquires information on a schedule of a user (e.g., schedule information defining an action schedule of the user) from the scheduler 2 (a schedule-information acquiring step) (S901).

The user estimating unit 102 estimates, on the basis of the information acquired in the schedule-information acquiring step, a user who is highly likely to use the image forming apparatus (a user estimating step) (S902).

Specifically, in the user estimating step, on the basis of the schedule information, a user moving to an installation location of the image forming apparatus 1 is estimated to be highly likely to use the image forming apparatus. The installation location in this context is, for example, a location where a meeting is held. The user moving to the installation location is, for example, a user planning to participate in the meeting to be held in the installation location.

The state-information acquiring unit 103 acquires state information concerning a motion state of the user estimated in the user estimating step (a state-information acquiring step) (S903). Specifically, in the state-information acquiring step, for example, information on a desk presence state of the user is acquired.

The process executing unit 104 causes, on the basis of the state information acquired in the state-information acquiring step, the image forming apparatus to execute a predetermined process for the user, the state information of whom is acquired (a process executing step) (S904).

Specifically, in the process executing step, on the basis of the state information acquired in the state-information acquiring step, it is preferable to cause the image forming apparatus to execute an image forming process for a print that should be distributed to the user, the state information of whom is acquired, and cause the image forming apparatus to perform a warming-up process for the image forming apparatus.

Further, in the process executing step, on the basis of the state information acquired in the state-information acquiring step, the image forming apparatus is caused to execute the image forming process and the warming-up process (predetermined processes) when the user, the state information of whom is acquired, leaves a desk of the user at time near time a predetermined time earlier than time when the user should arrive at the installation location. The “predetermined time” in this context is time required by the user, the state information of whom is acquired, to move from the desk of the user to the installation location.

The respective steps in the processes in the image forming apparatus described above are realized by causing the CPU 801 to execute an image forming process controlling program stored in the MEMORY 801.

In the explanation of this embodiment, the functions for carrying out the invention are recorded in the apparatus in advance. However, the invention is not limited to this. The same functions may be downloaded from the network to the apparatus or the same functions recorded in a recording medium may be installed in the apparatus. A form of the recording medium may be any form as long as the recording medium is a recording medium that can store a program and is readable by the apparatus such as a CD-ROM. The functions obtained by the installation or the download in advance in this way may be realized in cooperation with an OS (operating system) in the apparatus.

Besides, according to this embodiment, it is possible to provide an image forming apparatus that performs a predetermined process according to a motion state of a user, the image forming apparatus including the schedule-information acquiring unit 101 that acquires a schedule of the user, the state-information acquiring unit 103 that acquires state information concerning the motion state of the user, and the process executing unit 104 that causes the image forming apparatus to execute the predetermined process on the basis of the schedule and the state information.

In the respective embodiments described above, for example, motion states, schedules, and the like of plural users are monitored from one image forming apparatus and predetermined processes such as start of an image forming process and warming-up are executed on the basis of these kinds of information. However, the invention is not limited to this. For example, it is possible to provide an image forming process managing system that centrally manages plural image forming apparatuses using a server or the like, the image forming process managing system including a schedule-information acquiring unit that acquires a schedule of a user from the scheduler 2, a state-information acquiring unit that acquires a motion state such as a present position of the user from the state managing system 3, an arrangement-information acquiring unit that acquires information on arrangement locations of the plural image forming apparatuses, and an apparatus specifying unit that specifies, on the basis of the schedule and the state information, an image forming apparatus arranged in a location closest to the present position of the user or on a path to a destination in a movement schedule of the user, and the image forming process managing system performing printing of a material that should be printed for the user and a warming-up process in the image forming apparatus specified by the apparatus specifying unit.

In the image forming process managing system described above, it is also possible to cause an image forming apparatus arranged in a position closest to a moving destination of the user to perform a predetermined process on the basis of the schedule of the user or on the basis of the movement schedule of the user (e.g., a plan to participate in a meeting).

According to this embodiment, it is possible to provide an image forming process controlling program for causing a computer to execute a predetermined process corresponding to a motion state of a user, the image forming process controlling program causing the computer to execute a schedule information acquiring step of acquiring information on a schedule of the user, a user estimating step of estimating, on the basis of the information acquired in the schedule-information acquiring step, a user who is highly likely to use the image forming apparatus, a state-information acquiring step of acquiring state information concerning the motion state of the user estimated in the user estimating step, and a process executing step of causing, on the basis of the state information acquired in the state-information acquiring step, the image forming apparatus to execute the predetermined process for the user, the state information of whom is acquired.

In the image forming process controlling program having the constitution described above, it is preferable that the schedule-information acquiring step is a step of acquiring schedule information defining an action schedule of the user. In the user estimating step, it is preferable to estimate, on the basis of the schedule information, that a user moving to an installation location of the image forming apparatus is highly likely to use the image forming apparatus. In the image forming process controlling program having the constitution described above, it is possible to constitute the process executing step to cause, on the basis of the state information acquired in the state-information acquiring step, the image forming apparatus to execute an image forming process for a print that should be distributed to the user, the state information of whom is acquired. In the image forming process controlling program having the constitution described above, in the process executing step, it is also possible to cause, on the basis of the state information acquired in the state-information acquiring step, the image forming apparatus to perform a warming-up process for the image forming apparatus. In the image forming process controlling program having the constitution described above, it is preferable that the state-information acquiring step is a step of acquiring information on a desk presence state of the user. It is desirable that, in the process executing step, on the basis of the state information acquired in the state-information acquiring step, the image forming apparatus is caused to execute the predetermined process for the user, the state information of whom is acquired, when the user leaves a desk of the user at time near time a predetermined timer earlier than time when the user should arrive at the installation location. In the image forming process controlling program having the constitution described above, the predetermined time is time required by the user, the state information of whom is acquired, to move from the desk of the user to the installation location. Besides, in the image forming process controlling program having the constitution described above, it is preferable that the installation location is a location where a meeting is held and the user moving to the installation location is a user planning to participate in the meeting to be held in the installation location.

It is possible to prevent unnecessary printing and reduce a printing wait time of the user by starting printing when the user leaves the desk immediately before start of a meeting using information on a real-time desk presence state of the user as described above.

The specific modes of the invention have been explained in detail. However, it would be apparent for those skilled in the art that various alterations and modifications can be made without departing from the spirit and the scope of the invention.

As described above in detail, according to the invention, it is possible to provide a technique that can realize efficiency of control of an image forming process corresponding to a motion state of a user.

What is claimed is:

1. An image forming apparatus that performs a predetermined process according to a motion state of a user, the image forming apparatus comprising:
a schedule-information acquiring unit configured to acquire information on a schedule of the user;
a user estimating unit configured to estimate, on the basis of the information acquired by the schedule-information acquiring unit, a user who is highly likely to use the image forming apparatus;
a state-information acquiring unit configured to acquire state information concerning a motion state of the user estimated by the user estimating unit; and
a process executing unit configured to cause, on the basis of the state information acquired by the state-information acquiring unit, the image forming apparatus to execute the predetermined process for the user, the state information of whom is acquired.

2. An image forming apparatus according to claim 1, wherein
the schedule-information acquiring unit is a unit that acquires schedule information defining an action schedule of the user, and
the user estimating unit estimates, on the basis of the schedule information, that a user moving to an installation location of the image forming apparatus is highly likely to use the image forming apparatus.

3. An image forming apparatus according to claim 1, wherein the process executing unit causes, on the basis of the state information acquired by the state-information acquiring unit, the image forming apparatus to execute an image forming process for a print that should be distribute to the user, the state information of whom is acquired.

4. An image forming apparatus according to claim 1, wherein the process executing unit causes, on the basis of the state information acquired by the state-information acquiring unit, the image forming apparatus to perform a warming-up process for the image forming apparatus.

5. An image forming apparatus according to claim 1, wherein
the state-information acquiring unit is a unit that acquires information on a desk presence state of the user, and
the process executing unit causes, on the basis of the state information acquired by the state-information acquiring unit, the image forming apparatus to execute the predetermined process when the user, the state information of whom is acquired, leaves a desk at time near time a predetermined time earlier than time when the user should arrive at the installation location.

6. An image forming apparatus according to claim 5, wherein the predetermined time is time required by the user, the state information of whom is acquired, to move from the desk of the user to the installation location.

7. An image forming apparatus according to claim 2, wherein
the installation location is a location where a meeting is held, and
the user moving to the installation location is a user planning to participate in the meeting to be held in an installation location.

8. An image forming apparatus that performs a predetermined process according to a motion state of a user, the image forming apparatus comprising:
schedule-information acquiring means for acquiring information on a schedule of the user;
user estimating means for estimating, on the basis of the information acquired by the schedule-information acquiring means, a user who is highly likely to use the image forming apparatus;
state-information acquiring means for acquiring state information concerning a motion state of the user estimated by the user estimating means; and
process executing means for causing, on the basis of the state information acquired by the state-information acquiring means, the image forming apparatus to execute the predetermined process for the user, the state information of whom is acquired.

9. An image forming apparatus according to claim 8, wherein
the schedule-information acquiring means is means for acquiring schedule information defining an action schedule of the user, and
the user estimating means estimates, on the basis of the schedule information, that a user moving to an installation location of the image forming apparatus is highly likely to use the image forming apparatus.

10. An image forming apparatus according to claim 8, wherein the process executing means causes, on the basis of the state information acquired by the state-information acquiring means, the image forming apparatus to execute an image forming process for a print that should be distribute to the user, the state information of whom is acquired.

11. An image forming apparatus according to claim 8, wherein the process executing means causes, on the basis of the state information acquired by the state-information acquiring means, the image forming apparatus to perform a warming-up process for the image forming apparatus.

12. An image forming apparatus according to claim 8, wherein
the state-information acquiring means is means for acquiring information on a desk presence state of the user, and
the process executing means causes, on the basis of the state information acquired by the state-information acquiring means, the image forming apparatus to execute the predetermined process when the user, the state information of whom is acquired, leaves a desk at time near time a predetermined time earlier than time when the user should arrive at the installation location.

13. An image forming apparatus according to claim 12, wherein the predetermined time is time required by the user, the state information of whom is acquired, to move from the desk of the user to the installation location.

14. An image forming process controlling method of performing a predetermined process according to a motion state of a user, the image forming process controlling method comprising the steps of:
acquiring information on a schedule of the user;
estimating, on the basis of the information acquired in the step of acquiring information on schedule of the user, a user who is highly likely to use the image forming apparatus;
acquiring state information concerning a motion state of the user estimated in the step of estimating a user; and
causing, on the basis of the state information acquired in the step of acquiring state information, the image forming apparatus to execute the predetermined process for the user, the state information of whom is acquired.

15. An image forming process controlling method according to claim 14, wherein
the step of acquiring information on a schedule of the user is a step of acquiring schedule information defining an action schedule of the user, and
in the step of estimating a user, it is estimated, on the basis of the schedule information, that a user moving to an installation location of the image forming apparatus is highly likely to use the image forming apparatus.

16. An image forming process controlling method according to claim 14, wherein, in the step of causing the image forming apparatus to execute the predetermined process, the image forming apparatus is caused, on the basis of the state information acquired in the step of acquiring state information concerning a motion state of the user, to execute an image forming process for a print that should be distribute to the user, the state information of whom is acquired.

17. An image forming process controlling method according to claim 14, wherein, in the step of causing the image forming apparatus to execute the predetermined process, the image forming apparatus is caused, on the basis of the state information acquired in the step of acquiring state information concerning a motion state of the user, to perform a warming-up process for the image forming apparatus.

18. An image forming process controlling method according to claim 14, wherein
the step of acquiring state information concerning a motion state of the user is a step of acquiring information on a desk presence state of the user, and
in the step of causing the image forming apparatus to execute the predetermined process, the image forming apparatus is caused, on the basis of the state information acquired in the step of acquiring state information concerning a motion state of the user, to execute the predetermined process when the user, the state information of whom is acquired, leaves a desk at time near time a predetermined time earlier than time when the user should arrive at the installation location.

19. An image forming process controlling method according to claim 18, wherein the predetermined time is time required by the user, the state information of whom is acquired, to move from the desk of the user to the installation location.

20. An image forming process controlling method according to claim 15, wherein
the installation location is a location where a meeting is held, and
the user moving to the installation location is a user planning to participate in the meeting to be held in an installation location.
